(19) United States
(12) Patent Application Publication
(10) Pub. No.: US 2025/0086510 A1
(43) Pub. Date: Mar. 13, 2025

(54) INFERENCE AS A SERVICE

(71) Applicant: CenturyLink Intellectual Property LLC, Denver, CO (US)

(72) Inventors: Kevin M. McBride, Lone Tree, CO (US); Sotiri Terry Barbounis, Tucson, AZ (US); Scott Brindamour, Scituate, MA (US); Charles Stallings, Monument, CO (US); John R.B. Woodworth, Amissville, VA (US); Dean Ballew, Sterling, VA (US); Brian J. Strong, St. Louis, MO (US); Frank Moss, Chesterfield, MO (US)

(73) Assignee: CenturyLink Intellectual Property LLC, Denver, CO (US)

(21) Appl. No.: 18/829,449

(22) Filed: Sep. 10, 2024

Related U.S. Application Data
(60) Provisional application No. 63/581,842, filed on Sep. 11, 2023.

(51) Int. Cl. G06N 20/00

(52) U.S. Cl. CPC G06N 20/00

(57) ABSTRACT

Novel tools and techniques are provided for implementing Inference as a Service. In various embodiments, a computing system may receive a request to perform an AI/ML task on first data, the request including desired parameters, in some cases, without information regarding any of specific hardware, specific hardware type, specific location, or specific network for providing network services for performing the requested AI/ML task. The computing system may identify edge compute nodes within a network based on the desired parameters and/or unused processing capacity of each node. The computing system may identify AI/ML pipelines capable of performing the AI/ML task, the pipelines including neural networks utilizing pre-trained AI/ML models. The computing system may cause the identified nodes to run the identified pipelines to perform the AI/ML task. In response to receiving inference results from the identified pipelines, the computing system may send, store, and/or cause display of the received inference results.

### CROSS-REFERENCE TO RELATED APPLICATIONS

This application claims the benefit of U.S. Provisional Application No. 63/581,842 filed Sep. 11, 2023, by Kevin M. McBride et al., entitled “Inference as a Service,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network services orchestration, and, more particularly, to methods, systems, and apparatuses for implementing Inference as a Service.

### BACKGROUND

To configure a full end-to-end model training and Inferencing execution environment for artificial intelligence (“AI”) and/or machine learning (“ML”) workloads requires significant investment and technology deployment burden. At the same time, resources at edge network devices are underutilized. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 is a schematic diagram illustrating an example system for implementing Inference as a Service, in accordance with various embodiments.

FIG. 2 is a schematic diagram illustrating a non-limiting example map of an ecosystem for implementing end-to-end AI/ML training and inferencing execution framework, in accordance with various embodiments.

FIG. 3 is a schematic diagram illustrating another example system for implementing Inference as a Service, in accordance with various embodiments.

FIG. 4 is a schematic diagram illustrating yet another example system for implementing Inference as a Service, in accordance with various embodiments.

FIGS. 5A-5C are flow diagrams illustrating various example methods for implementing Inference as a Service, in accordance with various embodiments.

FIG. 6 is a block diagram illustrating an exemplary computer or system hardware architecture, in accordance with various embodiments.

FIG. 7 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing network services orchestration, and, more particularly, to methods, systems, and apparatuses for implementing Inference as a Service.

In various embodiments, a computing system may receive a request to perform an AI/ML task on first data, the request including desired characteristics and performance parameters for performing the AI/ML task, in some cases, without information regarding any of specific hardware, specific hardware type, specific location, or specific network for providing network services for performing the requested AI/ML task. The desired characteristics and performance parameters for performing the AI/ML task may include at least one of desired latency, desired geographical boundaries, or desired level of data sensitivity for performing the AI/ML task, and/or the like. The computing system may identify one or more edge compute nodes within a network based on the desired characteristics and performance parameters, in some cases, also based on unused processing capacity of each edge compute node. The computing system may also identify one or more AI/ML pipelines that are capable of performing the AI/ML task, the identified one or more AI/ML pipelines including neural networks utilizing pre-trained AI/ML models. The computing system may cause the identified one or more edge compute nodes to run the identified one or more AI/ML pipelines to perform the AI/ML task on the first data based on a corresponding pre-trained AI/ML model of each AI/ML pipeline. In response to receiving inference results from the identified one or more AI/ML pipelines, the computing system may perform at least one of sending the received inference results, storing the received inference results and sending information on a location where the received inference results are stored, or causing display of the received inference results, and/or the like.

In some aspects, Inference as a Service functionalities would allow for AI/ML workloads to run against pre-trained “inference pipelines” exposed as an Edge application programming interface (“API”) service and a flexible virtual graphics processing unit (“vGPU”) client-server relationship. Based on workload requirements, a customer may select to leverage individual file delivery for inference or to use pre-allocated GPU resources in the form of vGPU over Internet Protocol (“IP”) and/or GPU services exposed over a disaggregated composable infrastructure via electrical or optical based network services provided by a network services provider.

In this manner, Inference as a Service provides users or customers with full end-to-end AI/ML inference workload processing without significant investment and without technology deployment burden on the part of the users or customers. In some instances, the users or customers need only provide intent (e.g., desired latency, what type(s) of AI/ML inference tasks to perform, etc.) and either the data to be processed or the location of such data, without specifying hardware, hardware type, location, or network for providing network services for performing the requested inference workload task. At the same time, Inference as a Service identifies unused or underutilized edge nodes and/or resources at such edge nodes (e.g., based on the desired latency and level of unused resources at each edge node to select which edge nodes to use, etc.) to perform the requested inference workload task, thereby improving efficiency and utilization of the network and/or the network resources as a whole. These and other aspects of the Inference as a Service are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In an aspect, a method may include receiving, by a computing system, a request to perform an artificial intelligence (“AI”) and/or machine learning (“ML”) task on first data, the request including desired characteristics and performance parameters for performing the AI/ML task; identifying, by the computing system, one or more edge compute nodes within a network based on the desired characteristics and performance parameters; and identifying, by the computing system, one or more AI/ML pipelines that are capable of performing the AI/ML task, the identified one or more AI/ML pipelines including neural networks utilizing pre-trained AI/ML models. The method may further include causing, by the computing system, the identified one or more edge compute nodes to run the identified one or more AI/ML pipelines to perform the AI/ML task on the first data based on a corresponding pre-trained AI/ML model of each AI/ML pipeline; and, in response to receiving inference results from the identified one or more AI/ML pipelines, performing, by the computing system, at least one of sending the received inference results, storing the received inference results and sending information on a location where the received inference results are stored, or causing display of the received inference results, and/or the like.

In some embodiments, the computing system may include one of an Inference as a Service orchestrator, an AI/ML task manager, an edge compute orchestration system, an application management system, a service orchestration system, a user device associated with an entity, a server computer over the network, a cloud-based computing system over the network, or a distributed computing system, and/or the like. In some instances, the request may further include one of a location of the first data, a navigation link to the first data, or a copy of the first data, and/or the like. In some cases, the request may include the desired characteristics and performance parameters for performing the AI/ML task, without information regarding any of specific hardware, specific hardware type, specific location, or specific network for providing network services for performing the requested AI/ML task, and/or the like. In some instances, the desired characteristics and performance parameters for performing the AI/ML task may include at least one of desired latency, desired geographical boundaries, or desired level of data sensitivity for performing the AI/ML task, and/or the like.

According to some embodiments, receiving the request to perform the AI/ML task on the first data may include receiving, by the computing system and from a requesting device over the network, the request to perform the AI/ML task on the first data. In some instances, sending the received inference results and causing display of the received inference results may each include causing, by the computing system, the received inference results to be sent to the requesting device for display on a display screen of the requesting device. In some cases, sending the location where the received inference results are stored may include sending, by the computing system, information on a network storage location where the requesting device can access or download the received inference results for display on the display screen of the requesting device.

In some embodiments, the desired characteristics and performance parameters may include at least one of a maximum latency, a range of latency values, latency restrictions, or geographical restrictions for performing the AI/ML task, and/or the like. In some instances, identifying the one or more edge compute nodes may include identifying the one or more edge compute nodes based on at least one of proximity to the requesting device, network connections between each edge compute node and the requesting device, the at least one of the maximum latency, the range of latency values, the latency restrictions, or the geographical restrictions for performing the AI/ML task, and/or the like.

In some cases, receiving the request to perform the AI/ML task on the first data may include receiving, by the computing system and from the requesting device via an application programming interface (“API”) over the network, the request to perform the AI/ML task on the first data. In some instances, first data is uploaded to at least one of the computing system or the one or more edge compute nodes via the API. In some cases, causing the display of the received inference results may include pushing the received inference results to the requesting device via the API for display on the display device of the requesting device.

According to some embodiments, the computing system may include a user device associated with an entity. In some examples, receiving the request to perform the AI/ML task on the first data may include receiving, by a user interface device of the user device, user input including the request to perform the AI/ML task on the first data. In some instances, the identified one or more edge compute nodes may include one or more graphics processing units (“GPUs”). In some cases, causing the identified one or more edge compute nodes to run the identified one or more AI/ML pipelines to perform the AI/ML task on the first data may include causing, by the user device and over the network, the one or more GPUs to run the identified one or more AI/ML pipelines to perform the AI/ML task on the first data.

In some embodiments, the request may be received from a client device over the network. In some cases, the client device may have installed thereon a virtual GPU (“vGPU”) driver that is configured to manage and control one or more shared GPU resources. In some instances, the one or more shared GPU resources may include one or more composable GPUs, each composable GPU being a GPU that is one of local to each edge compute node among the identified one or more edge compute nodes or remote from said each edge compute node. In some examples, causing the identified one or more edge compute nodes to run the identified one or more AI/ML pipelines to perform the AI/ML task on the first data may include causing, by the computing system and in coordination with the identified one or more edge compute nodes, the vGPU driver on client device to manage and control at least one composable GPU among the one or more composable GPUs to run the identified one or more AI/ML pipelines to perform the AI/ML task on the first data based on a corresponding pre-trained AI/ML model of each AI/ML pipeline. In some cases, performing the at least one of sending the received inference results, storing the received inference results and sending information on a location where the received inference results are stored, or causing display of the received inference results, and/or the like, may include performing, by the computing system, at least one of sending the received inference results or causing display of the received inference results.

In some instances, for composable GPUs that are remote from the identified one or more edge compute nodes, causing the vGPU driver on client device to manage and control the at least one composable GPU among the one or more composable GPUs may include causing execution of an instance of a virtual network function (“VNF”) on a hypervisor that is communicatively coupled to client device. In some cases, executing the instance of the VNF causes GPU over Internet Protocol (“IP”) functionality in which the at least one composable GPU that is remote from said each identified edge compute node may be caused to perform the AI/ML task on the first data based on corresponding pre-trained AI/ML models and to provide inference results via said each identified edge compute node.

In some examples, identifying the one or more edge compute nodes may further include identifying, by the computing system, the one or more edge compute nodes further based on unused processing capacity of each edge compute node. In some cases, the AI/ML task may include a computer vision task, where the first data may include one of an image, a set of images, or one or more video frames, and/or the like. In some instances, performing the computer vision task may include performing at least one of image classification, object detection, or image segmentation on at least a portion of the first data, and/or the like, based on a corresponding pre-trained AI/ML model of each AI/ML pipeline. In some cases, identifying the one or more AI/ML pipelines may include: performing, by the computing system or by an edge compute node among the identified one or more edge compute nodes, preliminary image classification to identify types of objects depicted in the first data; and identifying, by the computing system, one or more AI/ML pipelines including neural networks utilizing models that have been pre-trained to perform computer vision tasks on the identified types of objects depicted in the first data.

According to some embodiments, the AI/ML task may include a natural language (“NL”) processing task. In some cases, the first data may include at least one of text input, a text prompt, a dialogue context, or example prompts and corresponding responses, and/or the like. In some instances, performing the NL processing task may include performing, by each edge compute node among the one or more edge compute nodes, at least one of text and speech processing, optical character recognition, speech recognition, speech segmentation, text-to-speech transformation, word segmentation, morphological analysis, lemmatization, morphological segmentation, part-of-speech tagging, stemming, syntactic analysis, grammar induction, sentence boundary disambiguation, parsing, lexical semantic analysis, distributional semantic analysis, named entity recognition, sentiment analysis, terminology extraction, word sense disambiguation, entity linking, relational semantic analysis, relationship extraction, semantic parsing, semantic role labelling, discourse analysis, coreference resolution, implicit semantic role labelling, textual entailment recognition, topic segmentation and recognition, argument mining, automatic text summarization, grammatical error correction, machine translation, natural language understanding, natural language generation, dialogue management, question answering, tokenization, dependency parsing, constituency parsing, stop-word removal, or text classification on at least a portion of the first data, and/or the like.

In some embodiments, the method may further include monitoring use of the identified one or more edge compute nodes and other network devices to track amount of consumed resources for performing the requested AI/ML task.

In another aspect, a system may include at least one first processor and a first non-transitory computer readable medium communicatively coupled to the at least one first processor. The first non-transitory computer readable medium may have stored thereon computer software including a first set of instructions that, when executed by the at least one first processor, causes the system to: receive, from a requesting device over a network, a request to perform an artificial intelligence (“AI”) and/or machine learning (“ML”) task on first data, the request including desired characteristics and performance parameters for performing the AI/ML task; identify one or more edge compute nodes within the network based on at least one of unused processing capacity of each edge compute node or the desired characteristics and performance parameters, the desired characteristics and performance parameters including at least one of a desired latency or geographical boundaries; identify one or more AI/ML pipelines that are capable of performing the AI/ML task, the identified one or more AI/ML pipelines including neural networks utilizing pre-trained AI/ML models; send instructions to each edge compute node among the identified one or more edge compute nodes to run the identified one or more AI/ML pipelines to perform the AI/ML task on the first data using a corresponding pre-trained AI/ML model of the edge compute node; and, in response to receiving inference results from the identified one or more AI/ML pipelines, perform at least one of sending the received inference results to the requesting device, storing the received inference results and sending information on a location where the received inference results are stored to the requesting device, or causing display of the received inference results on a display screen of the requesting device, and/or the like.

In yet another aspect, an edge compute node in a network may include at least one first processor; and a first non-transitory computer readable medium communicatively coupled to the at least one first processor. The first non-transitory computer readable medium may have stored thereon computer software including a first set of instructions that, when executed by the at least one first processor, causes the edge compute node to: receive, from a client device over a network, a request to perform an artificial intelligence (“AI”) and/or machine learning (“ML”) task on first data, wherein the request includes one of a location of the first data, a navigation link to the first data, or a copy of the first data, and/or the like; access the first data based on the one of the location of the first data, the navigation link to the first data, or the copy of the first data contained in the request, and/or the like; cause a virtual GPU (“vGPU”) driver that is installed on the client device to manage and control at least one composable GPU among the one or more composable GPUs to run one or more AI/ML pipelines to perform the AI/ML task on the first data based on a corresponding pre-trained AI/ML model of each AI/ML pipeline, the one or more shared GPU resources including one or more composable GPUs, each composable GPU being a GPU that is one of local to the edge compute node or remote from the edge compute node; and in response to receiving inference results from the one or more AI/ML pipelines, perform at least one of sending the received inference results over the network for display on a display screen of the client device or causing display of the received inference results on the display screen of the client device.

In some embodiments, for composable GPUs that are remote from the edge compute node, causing the vGPU driver to manage and control the at least one composable GPU among the one or more composable GPUs may include causing execution of an instance of a virtual network function (“VNF”) on a hypervisor that is communicatively coupled to the client device. In some instances, executing the instance of the VNF causes GPU over Internet Protocol (“IP”) functionality in which the at least one composable GPU that is remote from the edge compute node may be caused to perform the AI/ML task on the first data based on corresponding pre-trained AI/ML models and to provide inference results the edge compute node.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

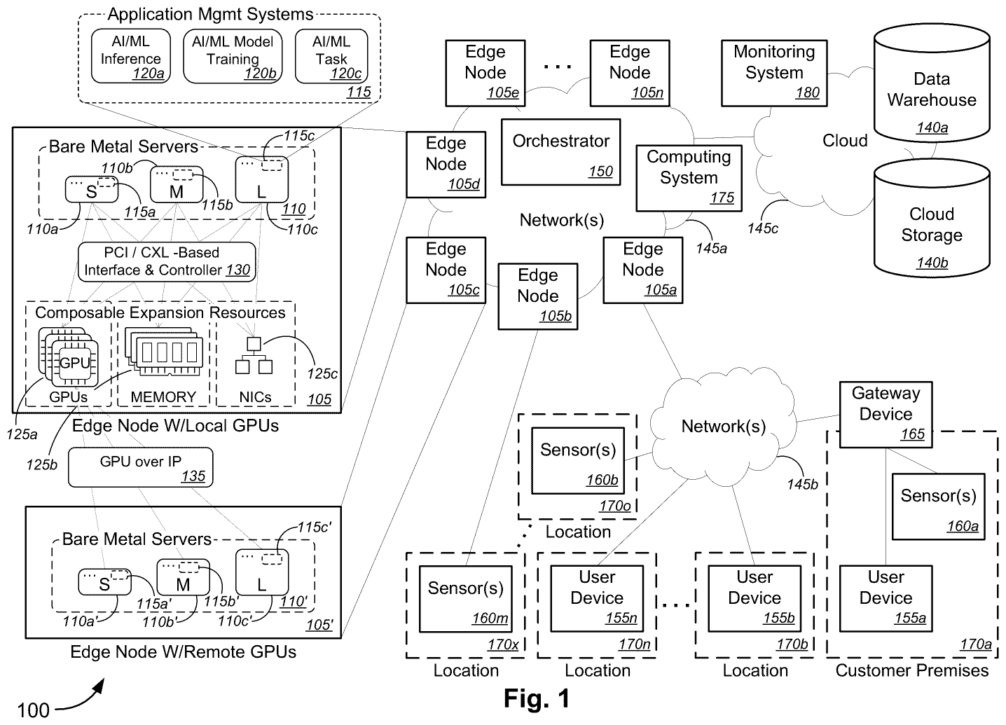

We now turn to the embodiments as illustrated by the drawings. FIGS. 1-7 illustrate some of the features of the method, system, and apparatus for implementing network services orchestration, and, more particularly, to methods, systems, and apparatuses for implementing Inference as a Service, as referred to above. The methods, systems, and apparatuses illustrated by FIGS. 1-7 refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

With reference to the figures, FIG. 1 is a schematic diagram illustrating an example system 100 for implementing Inference as a Service, in accordance with various embodiments.

In the non-limiting embodiment of FIG. 1, system 100 may include one or more edge nodes or edge compute nodes 105a-105n (collectively, “edge nodes” or “edge compute nodes” or the like). Each edge compute node 105a-105n may include one of an edge node 105 with local graphics processing units (“GPUs”) or an edge note 105′ with remote GPUs. Each edge node 105 may include one or more bare metal servers 110, which may include, but is not limited to, servers 110a-110c (collectively, “servers 110” or the like). Similarly, each edge node 105′ may include one or more bare metal servers 110′, which may include, but is not limited to, servers 110a′-110c′ (collectively, “servers 110′” or the like). Servers 110a-110c and 110a′-110c′ are either composable servers or servers whose size and/or functionalities may be adjusted (where FIG. 1 shows a relatively small sized server 110a, a relatively medium sized server 110b, and a relatively large sized server 110c). Servers 110a-110c and servers 110a′-110c′ may host corresponding one or more application management systems 115a-115c and 115a′-115c′ (collectively, “application management systems 115” or the like). Each application management system 115 may implement one or more of artificial intelligence (“AI”) and/or machine learning (“ML”) inference functions 120a, AI/ML model training functions 120b, and/or AI/ML tasks 120c, and/or the like. The servers 110a-110c and/or the application management systems 115 hosted thereon may utilize one or more of the composable expansion resources 125a-125c, via Peripheral Component Interconnect (“PCI”) and/or compute express link (“CXL”)-based interface and controller 130. In some examples, the PCI and/or CXL-based interface and controller 130 may include at least one of a PCI Express (“PCIe”) interface and controller, a CXL Fabric and controller, a disaggregation with CXL interface and controller, a CXL over Optics interface and controller, and/or a CXL over Ultra Ethernet interface and controller, and/or the like. The PCIe interface may connect together high speed peripheral devices like GPUs, field programmable gate arrays (“FPGAs”), high speed storage, and/or more. CXL fabric may provide composable, disaggregated memory, and/or PCIe devices. Disaggregation with CXL may provide efficient resource sharing and pooling. CXL over Optics may adapt the disaggregated resource connectivity to transmit over fiber optic networking infrastructure. CXL over Ultra Ethernet may adapt the disaggregated resource connectivity to transmit over the Ultra Ethernet Transport protocol for more efficient use of the Ethernet infrastructure. The composable expansion resources may include, without limitation, at least one of composable GPUs 125a, composable memory devices 125b, and/or network interface controllers 125c, and/or the like. The servers 110a′-110c′ and/or the application management systems 115 hosted thereon may utilize one or more of the composable expansion resources 125a-125c, via GPU over Internet protocol (“IP”) 135.

System 100 may further include data warehouse 140a and cloud storage 140b. In some embodiments, edge nodes 105, data warehouse 140a, and cloud storage 140b may be disposed or located within network(s) 145a-145c (collectively, “network(s) 145”). System 100 may further include at least one of orchestrator 150, one or more user devices 155a-155n (collectively, “user devices 155” or the like), one or more sensors 160a-160m (collectively, “sensors 160” or the like), and/or gateway device 165. The user device 155a, sensor(s) 160a, and gateway device 165 may be disposed or located within customer premises 170a. In some cases, customer premises 170a may include, but is not limited to, one of a residential customer premises, a business customer premises, a corporate customer premises, an enterprise customer premises, an education facility customer premises, a medical facility customer premises, or a governmental customer premises, and/or the like. The user devices 155b-155n may be disposed or located within corresponding locations 170b-170n. The sensors 160b-160m may be disposed or located within corresponding locations 170o-170x, where m>n, o>n, x>n, and x>o. Locations 170b-170x may include locations similar to customer premises 170a or other locations that are within proximity to (or have disposed or located therewithin) network access points for devices to connect to network(s) 145b, or the like. System 100 may further include computing system 175 and monitoring system 180.

According to some embodiments, network(s) 145a-145c may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 145a-145c may include an access network of the service provider (e.g., an Internet service provider (“ISP”)). In another embodiment, the network(s) 145a-145c may include a core network of the service provider and/or the Internet.

In some instances, the user device(s) 155a-155n may each include, but is not limited to, one of a desktop computer, a laptop computer, a tablet computer, a smart phone, a mobile phone, a network operations center (“NOC”) computing system or console, or any suitable device capable of communicating with network(s) 145 or with servers or other network devices within network(s) 145, or via any suitable device capable of communicating with at least one of the edge node(s) 105, the orchestrator 150, the computing system 175, and/or the monitoring system 180, in some cases, via gateway device 165, via a web-based portal, an application programming interface (“API”), a server, a software application (“app”), or any other suitable communications interface, or the like (not shown), over network(s) 145. In some embodiments, the computing system 175 may include, without limitation, one of an orchestrator (e.g., orchestrator 150, or the like), an AI/ML task manager, an application management system (e.g., application management system 115, or the like), a user device (e.g., user devices 155a-155n, or the like) associated with an entity, a server computer over the network, a cloud-based computing system over the network, or a distributed computing system, and/or the like. In some examples, orchestrator 150 may include, but is not limited to, at least one of an Inference as a Service orchestrator, an edge compute orchestration system, or a service orchestration system, and/or the like. In some instances, the monitoring system 180 may include any suitable AI/ML monitoring system for monitoring training and/or inferencing results of ML models, or any suitable network performance monitoring system for monitoring resources used during implementation of AI/ML tasks (whether during training or for inferencing).

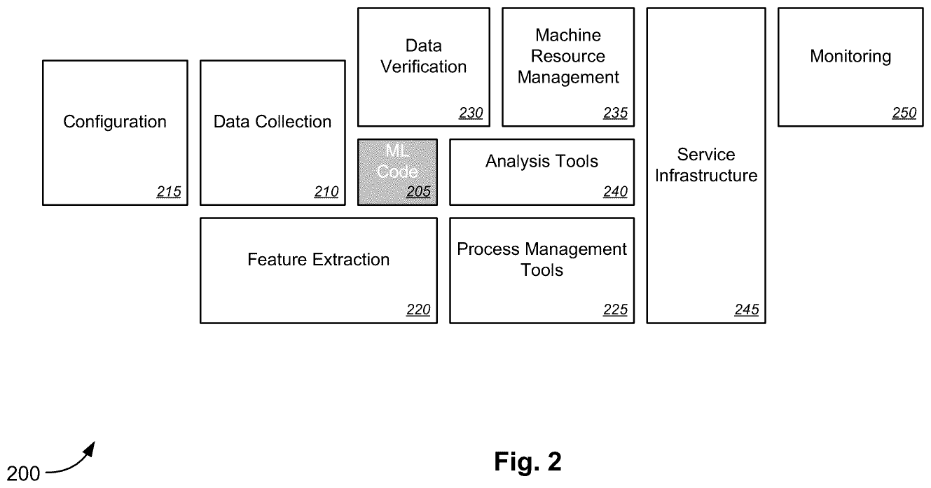

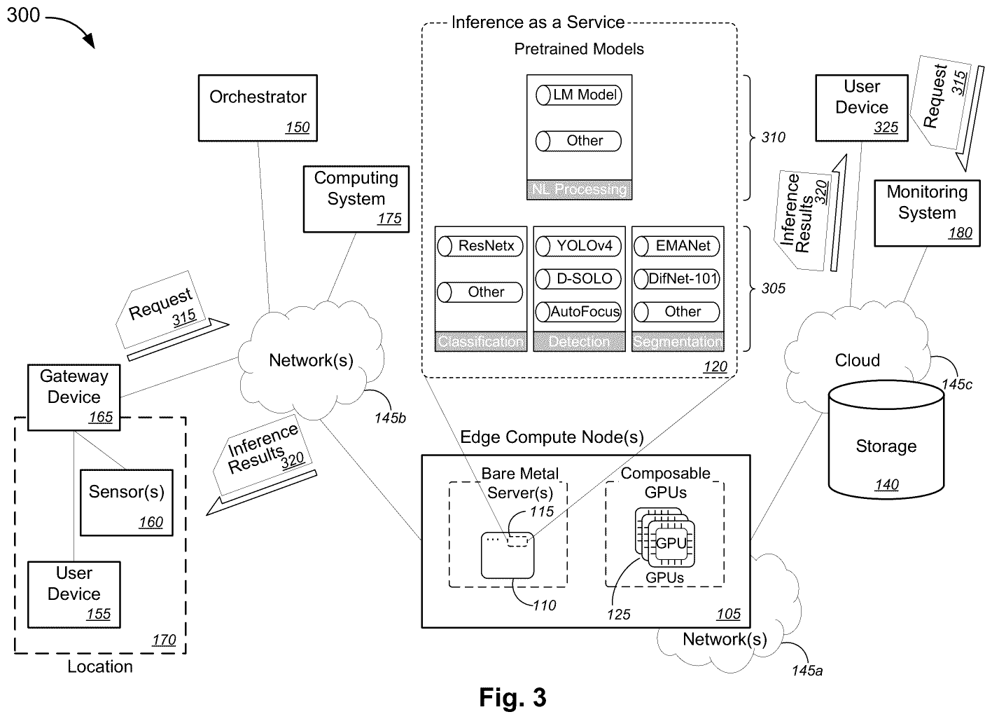

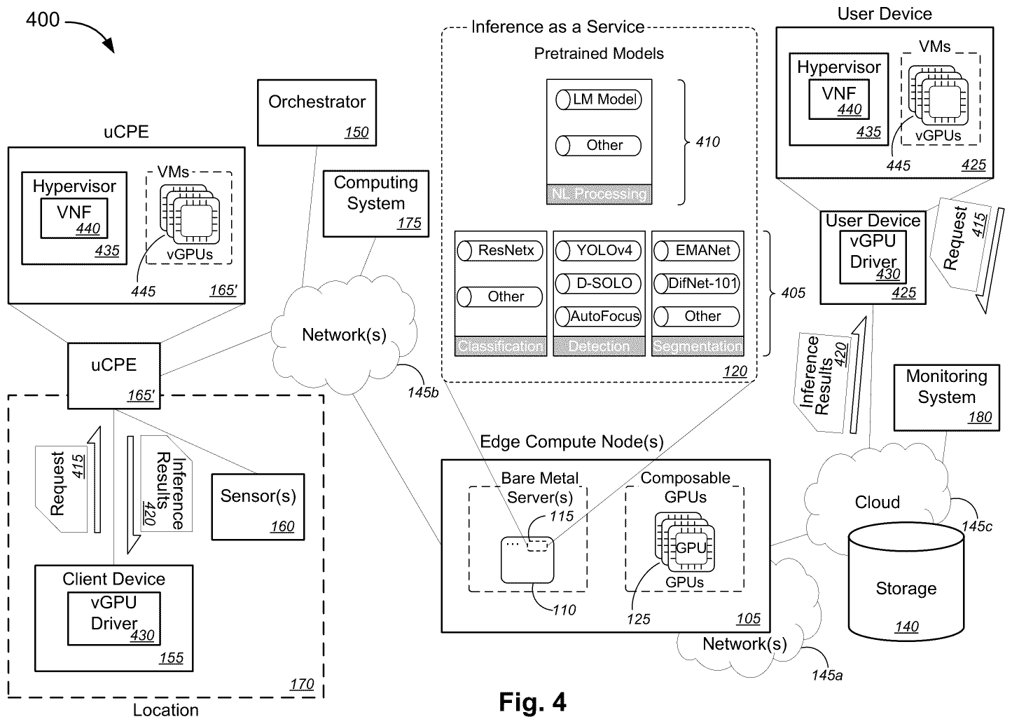

In operation, at least one edge compute node 105, the orchestrator 150, and/or the computing system 175 (collectively, “computing system”) may perform methods for implementing Inference as a Service, as described in detail with respect to FIGS. 2-4. For example, an example ecosystem map depicting components for implementing end-to-end AI/ML training and inferencing is described below with respect to FIG. 2, while data flows as described below with respect to FIGS. 3 and 4, which may utilize at least some of these components of FIG. 2, may be applied with respect to the operations of system 100 of FIG. 1. These and other functions of the system 100 (and its components) are described in greater detail below with respect to FIGS. 2-5. Although the examples described herein are directed to computer vision tasks or natural language (“NL”) tasks, the various embodiments may also be applicable to any suitable AI/ML tasks, further including, but not limited to, data processing tasks, ML model training tasks, image rendering tasks, video rendering tasks, and/or content generation tasks, and/or the like.

FIG. 2 is a schematic diagram illustrating a non-limiting example map 200 of an ecosystem for implementing end-to-end AI/ML training and inferencing execution framework, in accordance with various embodiments.

With reference to FIG. 2, ecosystem 200 may include components, processes, and/or tools including, without limitation, ML code 205, data collection 210, configuration 215, feature extraction 220, process management tools 225, data verification 230, machine resource management 235, analysis tools 240, serving infrastructure 245, and monitoring 250. In some embodiments, for training and inferencing of AI/ML models based on the ML code 205, particularly for computer vision tasks or NL processing tasks, the following processes may be performed and the following tools may be utilized.

Data collection 210 may be performed. For computer vision tasks, data collection 210 may include, without limitation, at least one of collecting data from sensors, retrieving data from data storage devices (e.g., hard drives, disk drives, compact discs (“CDs”), digital versatile discs (“DVDs”), magnetic disk storage devices, flash memory devices or memory cards, cloud storage devices, etc.), accessing data from the data storage devices, or receiving data in the request, and/or the like. In some examples, the sensors may include, but are not limited to, at least one of gamma-ray imaging sensors or systems, X-ray sensors or systems, ultraviolet (“UV”) imaging sensors or systems, RGB cameras (or visible light or color cameras), charge-coupled devices (“CCDs”), near-infrared imaging sensors or systems, mid-infrared imaging sensors or systems, far-infrared imaging sensors or systems, thermal infrared imaging devices, forward looking infrared (“FLIR”) cameras, terahertz imaging cameras, microwave imaging sensors or systems, radio-wave imaging sensors or systems, or ultrasound sensors, and/or the like. In some instances, the data that is collected may include, without limitation, at least one of an image, a set of images, or one or more video frames, and/or the like. Each image or video frame may include one of a gamma-ray image, X-ray image, UV image, RGB or color image, infrared (“IR”) image, thermal IR image, FLIR image, terahertz image, microwave image, radio-wave image, or ultrasound image, or the like. For NL processing tasks, data collection 210 may include, but is not limited to, at least one of retrieving data from data storage devices, accessing data from data storage devices, or receiving data in the request (or prompt), and/or the like. In some examples, the data may include, without limitation, at least one of text input data, voice-to-text input data, text data extracted from documents, text data extracted from websites, or optical character recognition (“OCR”) output data, and/or the like.

Configuration 215 may also be performed. For both computer vision tasks and NL processing tasks, configuration files for each type of task may be retrieved or accessed (e.g., from data storage devices, such as described above for storing data). In an example, configuration files may be used to configure the parameters and settings of a program or application, in some cases, to separate the ML code 205 from the parameters of the AI/ML pipeline to help produce repeatable outcomes. In another example, configuration files may be used to configure the hardware (e.g., edge nodes, edge compute nodes, GPUs running on edge nodes, etc.) to implement the ML code 205. Different configuration files may also be used for different AI/ML tasks, such as, for model training for computer vision tasks, for inferencing for computer vison tasks, for model training for NL processing tasks, for inferencing for NL processing tasks, for model training for data processing tasks, for inferencing for data processing tasks, for model training for image rendering tasks, for inferencing for image rendering tasks, for model training for video rendering tasks, for inferencing for video rendering tasks, for model training for content generation tasks, and/or for inferencing for content generation tasks, etc.

Feature extraction 220 may also be performed. For computer vision tasks, feature extraction 220 may include extracting features from the data that is collected, retrieved, accessed, or received, the extracted features being subsequently processed by implementing the ML code 205. For NL processing tasks, feature extraction 220 may include extracting features of text data, the extracted features being subsequently processed by implementing the ML code 205. Process management tools 225 may be utilized to manage the processes for implementing the computer vision tasks, for implementing the NL processing tasks, or for implementing other AI/ML tasks. Data verification 230 may be performed to verify the data collected during data collection 210. Machine resource management 235 may be utilized to manage resources for implementing the computer vision tasks, for implementing the NL processing tasks, or for implementing other AI/ML tasks. Analysis tools 240 may be utilized to analyze at least one of the ML code 205, the processing of the ML code 205, or the inferencing result from implementing the ML code 205, and/or the like. Service infrastructure 245, which is a foundational platform, may be utilized for creating, managing, securing, and consuming APIs and services across organizations (and/or across the network(s)). Service infrastructure 245 provides a wide range of features to service consumers and service providers, including authentication, authorization, auditing, rate limiting, analytics, billing, logging, and/or monitoring, or the like. Monitoring 250 may be used to perform at least one of monitoring the training of ML models, monitoring the inferencing of ML models, or monitoring resources used during implementation of AI/ML tasks utilizing the ML code 205, and/or the like. These and other functions of the example 200 (and its components) are described in greater detail herein with respect to FIGS. 1, 3, 4, and 5.

FIG. 3 is a schematic diagram illustrating another example system 300 for implementing Inference as a Service, in accordance with various embodiments.

In some embodiments, edge node(s) or edge compute node(s) 105, bare metal server(s) 110, application management system 115, Inference as a Service 120, composable GPUs 125, storage 140, networks 145a-145c, orchestrator 150, user device 155, sensor(s) 160, gateway device 165, location 170, computing system 175, and monitoring system 180 of FIG. 3 may be similar, if not identical, to the edge node(s) or edge compute node(s) 105, 105′, and 105a-105n, bare metal server(s) 110, 110′, 110a-110c, and 110a′-110c′, application management system 115, 115a-115c, and 115a′-115c′, AI/ML inference 120a, composable GPUs 125a, data warehouse 140a and/or cloud storage 140b, networks 145a-145c, orchestrator 150, user devices 155a-155n, sensor(s) 160a-160m, gateway device 165, customer premises or locations 170a-170x, computing system 175, and monitoring system 180, respectively, of system 100 of FIG. 1, and the description of these components of system 100 of FIG. 1 are similarly applicable to the corresponding components of FIG. 3.

In some examples, the application management system 115, which may be hosted on bare metal server(s) 110, may include, but is not limited to, Inference as a Service functionalities 120. Inference as a Service functionalities 120 may include pretrained models 305 and 310. The pretrained models 305 (also referred to as “pretrained computer vision models 305” or the like) may include, without limitation, at least one of AI/ML models for classification or image classification, AI/ML models for detection or object detection, or AI/ML models for segmentation or image segmentation, and/or the like.

In some instances, classification models may include, but are not limited to, at least one of neural architecture search model DA-NAS-C, split-attention network model ResNeSt-50, split-attention network model ResNeSt-101, residual neural network model ResNet-50-FReLU, residual neural network model ResNet-101-FReLU, residual neural network model ResNet-50-MEALv2, residual neural network model ResNet-50-MEALv2+CutMix, computer vision model MobileNet V3-Large-MEALv2, convolutional neural network model EfficientNet-B0-MEALv2, tokens-to-token vision transformer model T2T-VIT-7, tokens-to-token vision transformer model T2T-VIT-14, tokens-to-token vision transformer model T2T-VIT-19, normalizer free net model NFNet-F0, normalizer free net model NFNet-F1, normalizer free net model NFNet-F6+SAM (or sharpness-aware minimization), convolutional neural network model EfficientNetV2-S, convolutional neural network model EfficientNetV2-M, convolutional neural network model EfficientNetV2-L, convolutional neural network model EfficientNetV2-S (21k), convolutional neural network model EfficientNetV2-M (21k), or convolutional neural network model EfficientNetV2-L (21k), and/or the like.

In some cases, detection models may include, without limitation, at least one of deeply supervised object detector model DSOD, survival motor neuron model SMN, you-only-look-once detection model YOLOv3, structure inference net model SIN, scale-transferrable object detection network model STDN, refinement neural network model RefineDet, large mini-batch object detector model MegDet, receptive field block net detection model RFBNet, object detection model CornerNet, object detection model LibraRetinaNet, you-only-look-at-coefficient-Ts detection model YOLACT-700, neural architecture search detection model DetNASNet (3.8), you-only-look-once detection model YOLOv4, segmenting objects by locations detection model SOLO, segmenting objects by locations detection model D-SOLO, scale normalized image pyramids with efficient re-sampling detection model SNIPER, or scale normalized image pyramids with efficient re-sampling detection model AutoFocus, and/or the like.

In some examples, segmentation models may include, but are not limited to, at least one of global convolutional network GCN, segmentation-aware convolutional networks segmentation model Segaware, pixel deconvolutional network segmentation model PixelDCN, deep labelling segmentation model DeepLabv3, dense upsampling convolution/hybrid dilated convolution segmentation model DUC/HDC, computationally efficient segmentation network segmentation model ShuffleSeg, adapted segmentation model AdaptSegNet, dense upsampling convolution segmentation model TuSimple-DUC, recurrent residual convolutional neural network segmentation model R2U-Net, U-Net based segmentation model Attention U-Net, dual attention network segmentation model DANet, context encoding segmentation model ENCNet, semantic segmentation model ShelfNet, multi-path network segmentation model LadderNet, concentrated-comprehensive convolution segmentation model CCC-ERFnet, diffusion network segmentation model DifNet-101, bilateral segmentation network segmentation model BiSeNet (Res18), efficient spatial pyramid segmentation model ESPNet, spike pattern detection and evaluation segmentation model SPADE, seamless scene segmentation model SeamlessSeg, or expectation-maximization attention network segmentation model EMANet, and/or the like.

In some instances, the pretrained models 310 (also referred to as “NL processing models 310” or the like) may include language models (“LMs”) or large language models (“LLMs”), including, but not limited to, at least one of bidirectional encoder representations from transformers NL model BERT, robustly optimized BERT model ROBERTa, a lighter version of BERT model ALBERT, a word and sentence structured version of BERT model StructBert, other BERT-based models (e.g., ELMo, Big BIRD, ERNIE, Kermit, Grover, Rosita, etc.), generalized autoregressive model XLNet, generative pre-trained transformer 3 LLM GPT-3, generative pre-trained transformer 4 LLM GPT-4, language model for dialogue applications model LaMDA, or mixture of experts model MoE, and/or the like.

In some examples, a user device 155, which is disposed or located at location 170, may send, via gateway device 165, request 315 for performing an AI/ML task on first data. In some cases, gateway device 165 may include, but is not limited to, a network access point, a wireless access point, a network interface device, an optical network terminal, a modem, and/or the like. The request 315 may be received over network(s) 145b by orchestrator 150 and/or computing system 175 (which are described above with respect to FIG. 1, or the like). In some instances, receiving the request to perform the AI/ML task on the first data may include receiving, by a user interface device of the user device, user input including the request to perform the AI/ML task on the first data.

In some examples, the request 315 may include desired characteristics and performance parameters for performing the AI/ML task, in some cases, without information regarding any of specific hardware, specific hardware type, specific location, or specific network for providing network services for performing the requested AI/ML task, and/or the like. In some instances, the request 315 may further include one of a location of the first data, a navigation link to the first data, or a copy of the first data, and/or the like. In some examples, the location of the first data may be the storage device 140, and, in some cases, the navigation link may be a link to the storage device 140 and/or to a portion within the storage device 140. In some cases, the first data may be collected from one or more sensors 160 that are also located within location 170 or from one or more sensors located external to location 170 (not shown). The first data collected from the sensors may be sent to the user device 155 for including in or appending to the request 315, or may be stored in storage device 140, with navigation links to the storage device 140 and/or to portions of the storage device 140 being sent ot he user device 155 for including in or appending to the request 315.

In some instances, the desired characteristics and performance parameters for performing the AI/ML task may include at least one of desired latency (e.g., <1 ms, 1-5 ms, 10-100 ms, or greater, for network latency; e.g., <5 ms, 10-50 ms, 100-500 ms, or greater, for AI/ML task processing in addition to network latency; etc.), desired geographical boundaries (e.g., within particular states or countries, excluding particular states or countries, etc.), or desired level of data sensitivity (e.g., protecting personal information, protecting health information of users, protecting biometric information of users, protecting 3D models of users, or protecting other identity-revealing information of users, etc.) for performing the AI/ML task, and/or the like. In some cases, protection of data may be achieved using encryption (including, but not limited to, homomorphic encryption, or the like) prior to storage and transmission of sensitive data. The orchestrator 150 and/or computing system 175 (collectively, “computing system”) may identify one or more edge compute nodes 105 within the network 145 based on at least one of unused processing capacity of each edge compute node 105 or the desired characteristics and performance parameters, the desired characteristics and performance parameters including at least one of a desired latency or geographical boundaries (as described above).

The computing system may identify one or more AI/ML pipelines that are capable of performing the AI/ML task, the identified one or more AI/ML pipelines including neural networks utilizing pre-trained AI/ML models 305 or 310. In some examples, the computing system may curate particular pipelines with AI/ML models, which have been pre-trained for particular sets of tasks. Such particular pipelines for computer vision tasks may include, but are not limited to, at least one of (1) pipelines with AI/ML models pre-trained for classifying vehicles; (2) pipelines with AI/ML models pre-trained for classifying structures; (3) pipelines with AI/ML models pre-trained for classifying people; (4) pipelines with AI/ML models pre-trained for classifying animals; (5) pipelines with AI/ML models pre-trained for classifying objects; (6) pipelines with AI/ML models pre-trained for detecting vehicles; (7) pipelines with AI/ML models pre-trained for detecting structures; (8) pipelines with AI/ML models pre-trained for detecting people; (9) pipelines with AI/ML models pre-trained for detecting animals; (10) pipelines with AI/ML models pre-trained for detecting objects; (11) pipelines with AI/ML models pre-trained for segmenting vehicles; (12) pipelines with AI/ML models pre-trained for segmenting structures; (13) pipelines with AI/ML models pre-trained for segmenting people; (14) pipelines with AI/ML models pre-trained for segmenting animals; (15) pipelines with AI/ML models pre-trained for segmenting objects; and/or the like. In some cases, the computing system may maintain a list of top AI/ML models that are pre-trained for particular tasks (e.g., top 5 models for segmenting animals in image data, etc.).

Similarly, such pipelines for NL processing tasks may include, without limitation, at least one of (a) pipelines with AI/ML models pre-trained for text and speech processing tasks (each model pre-trained for one or more of optical character recognition, speech recognition, speech segmentation, text-to-speech transformation, or word segmentation, and/or the like); (b) pipelines with AI/ML models pre-trained for morphological analysis-based NL processing tasks (each model pre-trained for one or more of lemmatization, morphological segmentation, or part-of-speech tagging, stemming, and/or the like); (c) pipelines with AI/ML models pre-trained for syntactic analysis-based NL processing tasks (each model pre-trained for one or more of grammar induction, sentence boundary disambiguation, or parsing, and/or the like); (d) pipelines with AI/ML models pre-trained for lexical semantics-based NL processing tasks (each model pre-trained for one or more of lexical semantic analysis, distributional semantic analysis, named entity recognition, sentiment analysis, terminology extraction, word sense disambiguation, or entity linking, and/or the like); (e) pipelines with AI/ML models pre-trained for relational semantics-based NL processing tasks (each model pre-trained for one or more of relational semantic analysis, relationship extraction, semantic parsing, or semantic role labelling, and/or the like); (f) pipelines with AI/ML models pre-trained for discourse-based NL processing tasks (each model pre-trained for one or more of discourse analysis, coreference resolution, implicit semantic role labelling, textual entailment recognition, topic segmentation and recognition, or argument mining, and/or the like); (g) pipelines with AI/ML models pre-trained for higher-level NL processing applications (each model pre-trained for one or more of automatic text summarization, grammatical error correction, machine translation, natural language understanding, or natural language generation, and/or the like); (h) pipelines with AI/ML models pre-trained for other NL processing tasks (each model pre-trained for one or more of dialogue management, question answering, tokenization, dependency parsing, constituency parsing, stop-word removal, or text classification, and/or the like); and/or the like.

The computing system may send instructions to each edge compute node among the identified one or more edge compute nodes to run the identified one or more AI/ML pipelines to perform the AI/ML task on the first data using a corresponding pre-trained AI/ML model of the edge compute node. Prior to running the identified one or more AI/ML pipelines, the computing system or the identified one or more edge compute nodes may extract the first data from the request 315, retrieve the first data from the storage device 140, or access the first data from the storage device 140 (in some cases, based on any navigation links contained in the request 315), or the like. In running the identified one or more AI/ML pipelines, the identified one or more edge compute nodes 105 may run the Inference as a Service processes 120 on server 110 (using application management system 115). In some instances, the identified one or more edge compute nodes 105 may include one or more GPUs 125. In some cases, sending the instructions to the identified one or more edge compute nodes to run the identified one or more AI/ML pipelines to perform the AI/ML task on the first data may include causing the one or more GPUs 125 to run the identified one or more AI/ML pipelines to perform the AI/ML task on the first data. The GPUs 125 perform the hardware functions of processing the Inference as a Service functions 120 using the pretrained models 305 or 310 of the identified one or more AI/ML pipelines to output inference results 320.

In response to receiving inference results 320 from the identified one or more AI/ML pipelines, the computing system may perform at least one of sending the received inference results to the requesting device (e.g., user device 155), storing the received inference results (e.g., in storage device 140, or the like) and sending information on a location where the received inference results are stored to the requesting device, or causing display of the received inference results on a display screen of the requesting device, and/or the like. In some examples, sending the location where the received inference results are stored may include sending, by the computing system, information on a network storage location where the requesting device can access or download the received inference results for display on the display screen of the requesting device.

In some embodiments, the desired characteristics and performance parameters may include at least one of a maximum latency, a range of latency values, latency restrictions, or geographical restrictions for performing the AI/ML task, and/or the like. In some instances, identifying the one or more edge compute nodes may include identifying the one or more edge compute nodes based on at least one of proximity to the requesting device, network connections between each edge compute node and the requesting device, the at least one of the maximum latency, the range of latency values, the latency restrictions, or the geographical restrictions for performing the AI/ML task, and/or the like. For example, if a latency of 10-100 ms, or greater, for network latency or a latency of 100-500 ms, or greater, for AI/ML task processing in addition to network latency is indicated or chosen, then compute nodes in cloud network 145c may be used. If a latency of 1-5 ms for network latency or a latency of 10-50 ms for AI/ML task processing in addition to network latency is indicated or chosen, then edge compute nodes 105 in a network(s) 145a within a metro area may be used. If a latency of <1 ms for network latency or a latency of <5 ms for AI/ML task processing in addition to network latency is indicated or chosen, then edge compute nodes in a network(s) 145a within a locality (or neighborhood) or within a customer premises (such as customer premises 170a of FIG. 1, or the like) may be used.

In some cases, receiving the request to perform the AI/ML task on the first data may include receiving, by the computing system and from the requesting device via an application programming interface (“API”) over the network, the request to perform the AI/ML task on the first data. In some instances, first data is uploaded to at least one of the computing system or the one or more edge compute nodes via the API. In some cases, the API may include a HTTPS JSON based API. In some examples, causing the display of the received inference results may include pushing the received inference results to the requesting device via the API for display on the display device of the requesting device.

In some examples, the AI/ML task may include a computer vision task, where the first data may include one of an image, a set of images, or one or more video frames, and/or the like. In some instances, performing the computer vision task may include performing at least one of image classification, object detection, or image segmentation on at least a portion of the first data, and/or the like, based on a corresponding pre-trained AI/ML model of each AI/ML pipeline. In some cases, identifying the one or more AI/ML pipelines may include: performing, by the computing system or by an edge compute node among the identified one or more edge compute nodes, preliminary image classification to identify types of objects depicted in the first data; and identifying, by the computing system, one or more AI/ML pipelines including neural networks utilizing models that have been pre-trained to perform computer vision tasks on the identified types of objects depicted in the first data.

According to some embodiments, the AI/ML task may include a natural language (“NL”) processing task. In some cases, the first data may include at least one of text input, a text prompt, a dialogue context, or example prompts and corresponding responses, and/or the like. In some instances, performing the NL processing task may include performing, by each edge compute node among the one or more edge compute nodes, at least one of text and speech processing, optical character recognition, speech recognition, speech segmentation, text-to-speech transformation, word segmentation, morphological analysis, lemmatization, morphological segmentation, part-of-speech tagging, stemming, syntactic analysis, grammar induction, sentence boundary disambiguation, parsing, lexical semantic analysis, distributional semantic analysis, named entity recognition, sentiment analysis, terminology extraction, word sense disambiguation, entity linking, relational semantic analysis, relationship extraction, semantic parsing, semantic role labelling, discourse analysis, coreference resolution, implicit semantic role labelling, textual entailment recognition, topic segmentation and recognition, argument mining, automatic text summarization, grammatical error correction, machine translation, natural language understanding, natural language generation, dialogue management, question answering, tokenization, dependency parsing, constituency parsing, stop-word removal, or text classification on at least a portion of the first data, and/or the like.

In some embodiments, monitoring system 180 may monitor use of the identified one or more edge compute nodes and other network devices to track amount of consumed resources for performing the requested AI/ML task. The user can then be charged or billed based on the amount of consumed resources, which may be tracked based on time of use of such resources (e.g., per millisecond of use, or the like). Alternative to the user device 155 sending the request 315 and subsequently receiving the inference results 320, user device 325, which is external to location 170 and connected to cloud network 145c, may send the request 315 and may subsequently receive the inference results 320.

In some aspects, a user or the system calls an Inference as a Service API, which responds with uniform resource locator (“URL”) targets to submit an image file for a classification, segmentation and/or detection inferencing task. The user provides a URL for the object storage location for inferencing systems to pull the image file for processing or the user pushes the image file directly via API-BLOB, http, https, other transport for inferencing. When complete, the Inference as a Service API responds with a location to fetch post-inferencing blocked-image file and data files or job status. Herein, BLOB may refer to an object that represents a blob, which is a file-like object of immutable, raw data; the blob can be read as text or binary data, or converted into a readable stream of byte data so that its methods can be used for processing the data. Herein, “blocked-image” may refer to a marked-up inference result image with colored boxes around detected objects or colored highlighting and outlining of such detected objects for image segmentation.

These and other functions of the example 300 (and its components) are described in greater detail herein with respect to FIGS. 1, 2, 4, and 5.

FIG. 4 is a schematic diagram illustrating yet another example system 400 for implementing Inference as a Service, in accordance with various embodiments.

In some embodiments, edge node(s) or edge compute node(s) 105, bare metal server(s) 110, application management system 115, Inference as a Service 120, composable GPUs 125, storage 140, networks 145a-145c, orchestrator 150, client device 155, sensor(s) 160, universal customer premises equipment (“uCPE”) 165′, location 170, computing system 175, and monitoring system 180 of FIG. 4 may be similar, if not identical, to the edge node(s) or edge compute node(s) 105, 105′, and 105a-105n, bare metal server(s) 110, 110′, 110a-110c, and 110a′-110c′, application management system 115, 115a-115c, and 115a′-115c′, AI/ML inference 120a, composable GPUs 125a, data warehouse 140a and/or cloud storage 140b, networks 145a-145c, orchestrator 150, user devices 155a-155n, sensor(s) 160a-160m, gateway device 165, customer premises or locations 170a-170x, computing system 175, and monitoring system 180, respectively, of system 100 of FIG. 1, and the description of these components of system 100 of FIG. 1 are similarly applicable to the corresponding components of FIG. 4. Likewise, edge node(s) or edge compute node(s) 105, bare metal server(s) 110, application management system 115, Inference as a Service 120, composable GPUs 125, storage 140, networks 145a-145c, orchestrator 150, client device 155, sensor(s) 160, uCPE 165′, location 170, computing system 175, monitoring system 180, pre-trained models 405 and 410, request 415, inference results 420, and user device 425 of FIG. 4 may be similar, if not identical, to the edge node(s) or edge compute node(s) 105, 105′, and 105a-105n, bare metal server(s) 110, 110′, 110a-110c, and 110a′-110c′, application management system 115, 115a-115c, and 115a′-115c′, AI/ML inference 120a, composable GPUs 125a, data warehouse 140a and/or cloud storage 140b, networks 145a-145c, orchestrator 150, user devices 155a-155n, sensor(s) 160a-160m, gateway device 165, customer premises or locations 170a-170x, computing system 175, monitoring system 180, pre-trained models 305 and 310, request 315, inference results 320, and user device 325, respectively, of system 300 of FIG. 3, and the description of these components of system 300 of FIG. 3 are similarly applicable to the corresponding components of FIG. 4.

The example system 400 is similar, if not identical, to example system 300, except that a virtual GPU (“vGPU”) 430 is installed on a client device 155 (similar to user device 155 of FIG. 3 or the like) or user device 425 (similar to user device 325 of FIG. 3, or the like), uCPE 165′ (which is similar to gateway device 165 of FIGS. 1 and 3, or the like) further includes a hypervisor 435 on which virtual network functions (“VNFs”) 440 may be instantiated. In some examples, the vGPU driver 430 is configured to manage and control one or more shared GPU resources. In some instances, the one or more shared GPU resources may include one or more composable GPUs 125, each composable GPU 125 being a GPU that is one of local to each edge compute node among the identified one or more edge compute nodes or remote from said each edge compute node. The vGPU driver 430 on client device 155 (or on the user device 425) manages and controls at least one composable GPU among the one or more composable GPUs to run the identified one or more AI/ML pipelines to perform the AI/ML task on the first data based on a corresponding pre-trained AI/ML model of each AI/ML pipeline.

In some instances, for composable GPUs that are remote from the identified one or more edge compute nodes, causing the vGPU driver on client device to manage and control the at least one composable GPU among the one or more composable GPUs may include causing execution of an instance of a VNF 440 on a hypervisor 435 that is communicatively coupled to client device 155 (e.g., hypervisor 435 of uCPE 165′ or the like) or user device 425 (e.g., hypervisor 435 of user device 425 or the like). In some cases, executing the instance of the VNF causes GPU over Internet Protocol (“IP”) functionality in which the at least one composable GPU that is remote from said each identified edge compute node may be caused to perform the AI/ML task on the first data based on corresponding pre-trained AI/ML models and to provide inference results via said each identified edge compute node.

In some examples, the VNF 440 when instantiated on hypervisor 435 causes instantiation of vGPUs 445 functioning as virtual machines on the uCPE 165′ or the user device 425, and the vGPU driver manages and controls the vGPUs 445 to run the identified one or more AI/ML pipelines to perform the AI/ML task on the first data based on a corresponding pre-trained AI/ML model of each AI/ML pipeline.

In some aspects, a user or the system calls an Inference as a Service API to establish vGPU-based Inference as a Service. In this example, a vGPU client is first installed on the user's system to provide integration with the user's host operating system and presenting, to the operating system, a GPU driver with native-like integration with libraries (e.g., compute unified device architecture (“CUDA”) libraries, Vulkan open standard modern GPU API libraries, direct machine learning (“DirectML”) libraries, and/or other AI/ML libraries, etc.). For this example, the user can use both pre-trained inference pipelines and their own on-premise systems for some portions of the inferencing task.

These and other functions of the example 400 (and its components) are described in greater detail herein with respect to FIGS. 1-3, and 5.

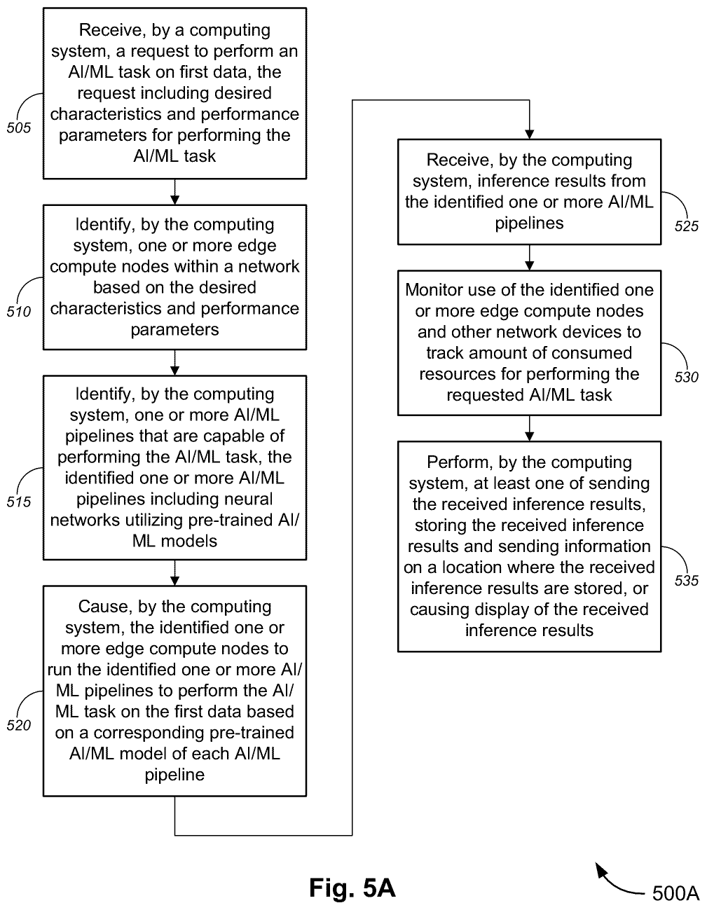

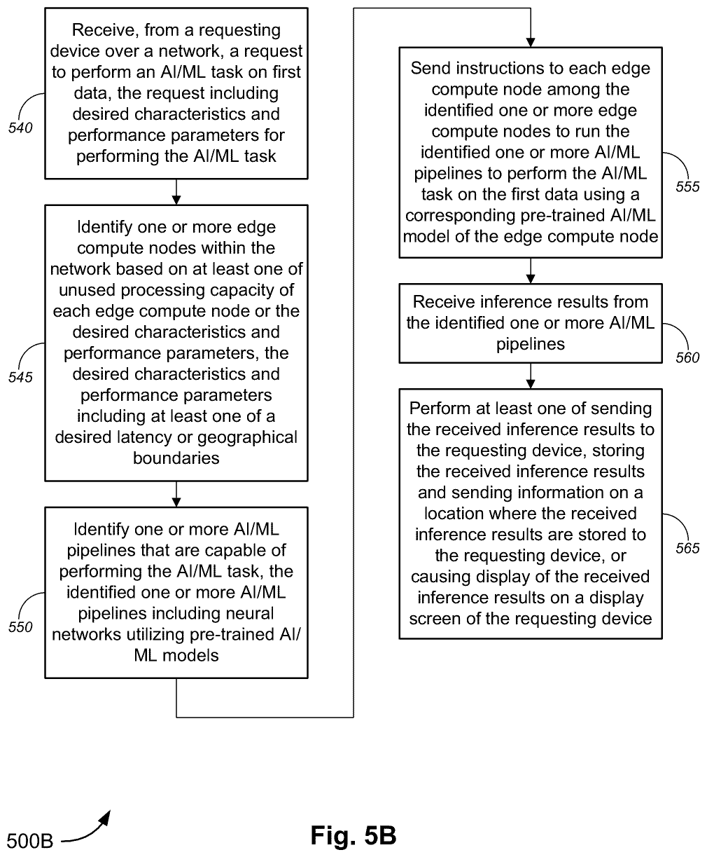

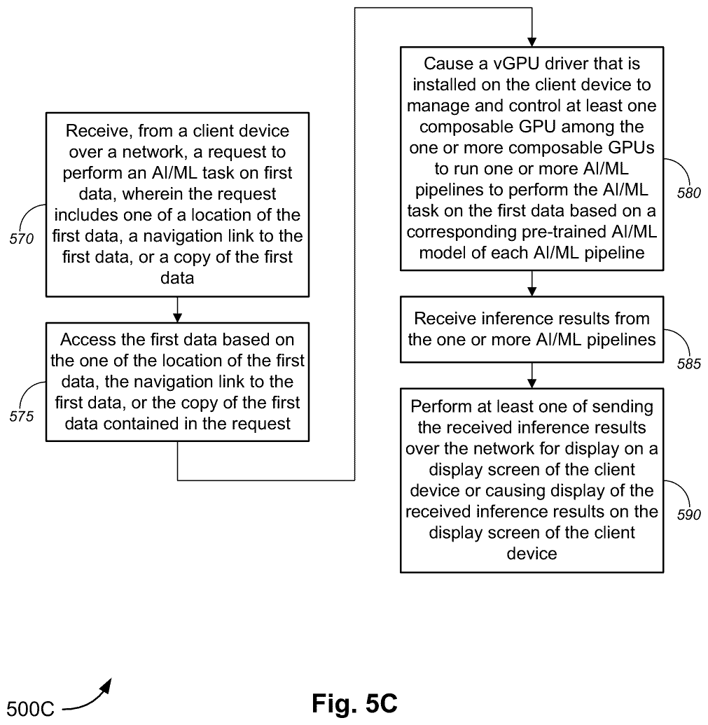

FIGS. 5A-5C (collectively, “FIG. 5”) are flow diagrams illustrating various example methods 500A, 500B, and 500C for implementing Inference as a Service, in accordance with various embodiments.

In the non-limiting embodiment of FIG. 5A, method 500A, at operation 505, may include receiving, by a computing system, a request to perform an AI/ML task on first data, the request including desired characteristics and performance parameters for performing the AI/ML task. Method 500A may further include identifying, by the computing system, one or more edge compute nodes within a network based on the desired characteristics and performance parameters (at operation 510) and identifying, by the computing system, one or more AI/ML pipelines that are capable of performing the AI/ML task, the identified one or more AI/ML pipelines including neural networks utilizing pre-trained AI/ML models (at operation 515).

At operation 520, method 500A may include causing, by the computing system, the identified one or more edge compute nodes to run the identified one or more AI/ML pipelines to perform the AI/ML task on the first data based on a corresponding pre-trained AI/ML model of each AI/ML pipeline. Method 500A may further include, at operation 525, receiving, by the computing system, inference results from the identified one or more AI/ML pipelines. Method 500A, at operation 530, monitoring use of the identified one or more edge compute nodes and other network devices to track amount of consumed resources for performing the requested AI/ML task. Method 500A may further include performing, by the computing system, at least one of sending the received inference results, storing the received inference results and sending information on a location where the received inference results are stored, or causing display of the received inference results, and/or the like (at operation 535).

In some embodiments, the computing system may include one of an Inference as a Service orchestrator, an AI/ML task manager, an edge compute orchestration system, an application management system, a service orchestration system, a user device associated with an entity, a server computer over the network, a cloud-based computing system over the network, or a distributed computing system, and/or the like. In some instances, the request may further include one of a location of the first data, a navigation link to the first data, or a copy of the first data, and/or the like. In some cases, the request may include the desired characteristics and performance parameters for performing the AI/ML task, without information regarding any of specific hardware, specific hardware type, specific location, or specific network for providing network services for performing the requested AI/ML task, and/or the like. In some instances, the desired characteristics and performance parameters for performing the AI/ML task may include at least one of desired latency, desired geographical boundaries, or desired level of data sensitivity for performing the AI/ML task, and/or the like.

According to some embodiments, receiving the request to perform the AI/ML task on the first data may include receiving, by the computing system and from a requesting device over the network, the request to perform the AI/ML task on the first data. In some instances, sending the received inference results and causing display of the received inference results may each include causing, by the computing system, the received inference results to be sent to the requesting device for display on a display screen of the requesting device. In some cases, sending the location where the received inference results are stored may include sending, by the computing system, information on a network storage location where the requesting device can access or download the received inference results for display on the display screen of the requesting device.

In some embodiments, the desired characteristics and performance parameters may include at least one of a maximum latency, a range of latency values, latency restrictions, or geographical restrictions for performing the AI/ML task, and/or the like. In some instances, identifying the one or more edge compute nodes may include identifying the one or more edge compute nodes based on at least one of proximity to the requesting device, network connections between each edge compute node and the requesting device, the at least one of the maximum latency, the range of latency values, the latency restrictions, or the geographical restrictions for performing the AI/ML task, and/or the like.

In some cases, receiving the request to perform the AI/ML task on the first data may include receiving, by the computing system and from the requesting device via an API over the network, the request to perform the AI/ML task on the first data. In some instances, first data is uploaded to at least one of the computing system or the one or more edge compute nodes via the API. In some cases, causing the display of the received inference results may include pushing the received inference results to the requesting device via the API for display on the display device of the requesting device.

According to some embodiments, the computing system may include a user device associated with an entity. In some examples, receiving the request to perform the AI/ML task on the first data may include receiving, by a user interface device of the user device, user input including the request to perform the AI/ML task on the first data. In some instances, the identified one or more edge compute nodes may include one or more GPUs. In some cases, causing the identified one or more edge compute nodes to run the identified one or more AI/ML pipelines to perform the AI/ML task on the first data may include causing, by the user device and over the network, the one or more GPUs to run the identified one or more AI/ML pipelines to perform the AI/ML task on the first data.

In some embodiments, the request may be received from a client device over the network. In some cases, the client device may have installed thereon a vGPU driver that is configured to manage and control one or more shared GPU resources. In some instances, the one or more shared GPU resources may include one or more composable GPUs, each composable GPU being a GPU that is one of local to each edge compute node among the identified one or more edge compute nodes or remote from said each edge compute node. In some examples, causing the identified one or more edge compute nodes to run the identified one or more AI/ML pipelines to perform the AI/ML task on the first data may include causing, by the computing system and in coordination with the identified one or more edge compute nodes, the vGPU driver on client device to manage and control at least one composable GPU among the one or more composable GPUs to run the identified one or more AI/ML pipelines to perform the AI/ML task on the first data based on a corresponding pre-trained AI/ML model of each AI/ML pipeline. In some cases, performing the at least one of sending the received inference results, storing the received inference results and sending information on a location where the received inference results are stored, or causing display of the received inference results, and/or the like, may include performing, by the computing system, at least one of sending the received inference results or causing display of the received inference results.

In some instances, for composable GPUs that are remote from the identified one or more edge compute nodes, causing the vGPU driver on client device to manage and control the at least one composable GPU among the one or more composable GPUs may include causing execution of an instance of a VNF on a hypervisor that is communicatively coupled to client device. In some cases, executing the instance of the VNF causes GPU over IP functionality in which the at least one composable GPU that is remote from said each identified edge compute node may be caused to perform the AI/ML task on the first data based on corresponding pre-trained AI/ML models and to provide inference results via said each identified edge compute node.

In some examples, identifying the one or more edge compute nodes may further include identifying, by the computing system, the one or more edge compute nodes further based on unused processing capacity of each edge compute node. In some cases, the AI/ML task may include a computer vision task, where the first data may include one of an image, a set of images, or one or more video frames, and/or the like. In some instances, performing the computer vision task may include performing at least one of image classification, object detection, or image segmentation on at least a portion of the first data, and/or the like, based on a corresponding pre-trained AI/ML model of each AI/ML pipeline. In some cases, identifying the one or more AI/ML pipelines may include: performing, by the computing system or by an edge compute node among the identified one or more edge compute nodes, preliminary image classification to identify types of objects depicted in the first data; and identifying, by the computing system, one or more AI/ML pipelines including neural networks utilizing models that have been pre-trained to perform computer vision tasks on the identified types of objects depicted in the first data.

According to some embodiments, the AI/ML task may include an NL processing task. In some cases, the first data may include at least one of text input, a text prompt, a dialogue context, or example prompts and corresponding responses, and/or the like. In some instances, performing the NL processing task may include performing, by each edge compute node among the one or more edge compute nodes, at least one of text and speech processing, optical character recognition, speech recognition, speech segmentation, text-to-speech transformation, word segmentation, morphological analysis, lemmatization, morphological segmentation, part-of-speech tagging, stemming, syntactic analysis, grammar induction, sentence boundary disambiguation, parsing, lexical semantic analysis, distributional semantic analysis, named entity recognition, sentiment analysis, terminology extraction, word sense disambiguation, entity linking, relational semantic analysis, relationship extraction, semantic parsing, semantic role labelling, discourse analysis, coreference resolution, implicit semantic role labelling, textual entailment recognition, topic segmentation and recognition, argument mining, automatic text summarization, grammatical error correction, machine translation, natural language understanding, natural language generation, dialogue management, question answering, tokenization, dependency parsing, constituency parsing, stop-word removal, or text classification on at least a portion of the first data, and/or the like.

In some embodiments, the method may further include monitoring use of the identified one or more edge compute nodes and other network devices to track amount of consumed resources for performing the requested AI/ML task.

Alternative to the embodiment 500A of FIG. 5A, with reference to the non-limiting embodiment of FIG. 5B, method 500B, at operation 540, may include receiving, from a requesting device over a network, a request to perform an AI/ML task on first data, the request including desired characteristics and performance parameters for performing the AI/ML task. Method 500B may further include, at operation 545, identifying one or more edge compute nodes within the network based on at least one of unused processing capacity of each edge compute node or the desired characteristics and performance parameters, the desired characteristics and performance parameters including at least one of a desired latency or geographical boundaries. Method 500B, at operation 550, may include identifying one or more AI/ML pipelines that are capable of performing the AI/ML task, the identified one or more AI/ML pipelines including neural networks utilizing pre-trained AI/ML models. At operation 555, method 500B, sending instructions to each edge compute node among the identified one or more edge compute nodes to run the identified one or more AI/ML pipelines to perform the AI/ML task on the first data using a corresponding pre-trained AI/ML model of the edge compute node. Method 500B may further include, at operation 560, receiving inference results from the identified one or more AI/ML pipelines. Method 500B may further include performing at least one of sending the received inference results to the requesting device, storing the received inference results and sending information on a location where the received inference results are stored to the requesting device, or causing display of the received inference results on a display screen of the requesting device, and/or the like (at operation 565).

Alternative to the embodiment 500A of FIG. 5A or the embodiment 500B of FIG. 5B, referring to the non-limiting embodiment of FIG. 5C, method 500C, at operation 570, may include receiving, from a client device over a network, a request to perform an AI/ML task on first data, the request including one of a location of the first data, a navigation link to the first data, or a copy of the first data, and/or the like. In some embodiments, method 500C may further include accessing the first data based on the one of the location of the first data, the navigation link to the first data, or the copy of the first data contained in the request, and/or the like (at operation 575). Method 500C, at operation 580, may include causing a vGPU driver that is installed on the client device to manage and control at least one composable GPU among the one or more composable GPUs to run one or more AI/ML pipelines to perform the AI/ML task on the first data based on a corresponding pre-trained AI/ML model of each AI/ML pipeline, the one or more shared GPU resources including one or more composable GPUs, each composable GPU being a GPU that is one of local to the edge compute node or remote from the edge compute node. At operation 585, method 500C may include receiving inference results from the one or more AI/ML pipelines. Method 500C may further include performing at least one of sending the received inference results over the network for display on a display screen of the client device or causing display of the received inference results on the display screen of the client device, and/or the like (at operation 590).

In some embodiments, for composable GPUs that are remote from the edge compute node, causing the vGPU driver to manage and control the at least one composable GPU among the one or more composable GPUs may include causing execution of an instance of a VNF on a hypervisor that is communicatively coupled to the client device. In some instances, executing the instance of the VNF causes GPU over IP functionality in which the at least one composable GPU that is remote from the edge compute node may be caused to perform the AI/ML task on the first data based on corresponding pre-trained AI/ML models and to provide inference results the edge compute node.

While the techniques and procedures are depicted and/or described in a certain order for purposes of illustration, it should be appreciated that certain procedures may be reordered and/or omitted within the scope of various embodiments. Moreover, while the methods 500A-500C illustrated by FIGS. 5A-5C can be implemented by or with (and, in some cases, are described above with respect to) the systems, examples, or embodiments 100, 200, 300, and 400 of FIGS. 1, 2, 3, and 4, respectively (or components thereof), such methods may also be implemented using any suitable hardware (or software) implementation. Similarly, while each of the systems, examples, or embodiments 100, 200, 300, and 400 of FIGS. 1, 2, 3, and 4, respectively (or components thereof), can operate according to the methods 500A-500C illustrated by FIGS. 5A-5C (e.g., by executing instructions embodied on a computer readable medium), the systems, examples, or embodiments 100, 200, 300, and 400 of FIGS. 1, 2, 3, and 4 can each also operate according to other modes of operation and/or perform other suitable procedures.

### Exemplary System and Hardware Implementation

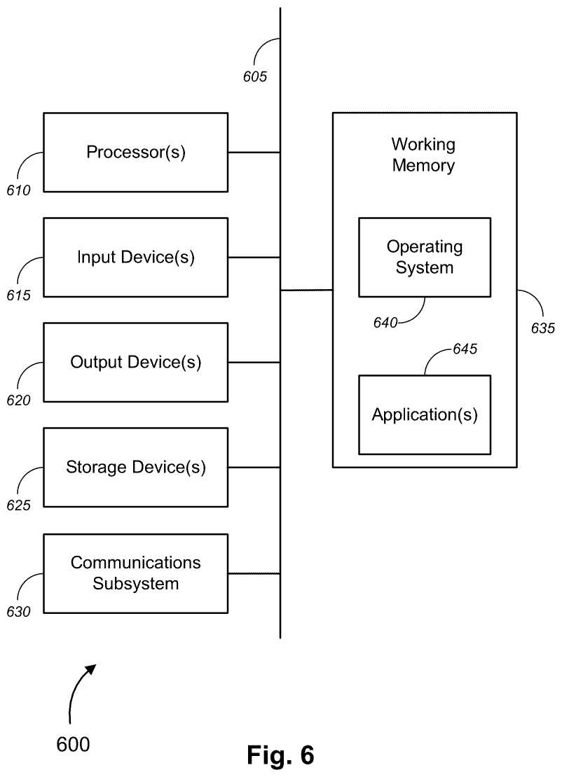

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., edge nodes or edge compute nodes 105, 105′, and 105a-105n, bare metal servers 110, 110′, 110a-110c, and 110a′-110c′, PCI and/or CXL-based interface and controller 130, orchestrator 150, user devices and client devices 155, 155a-155n, 325, and 425, gateway device 165, universal customer premises equipment (“uCPE”) 165′, computing system 175, and monitoring system 180, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., edge nodes or edge compute nodes 105, 105′, and 105a-105n, bare metal servers 110, 110′, 110a-110c, and 110a′-110c′, PCI and/or CXL-based interface and controller 130, orchestrator 150, user devices and client devices 155, 155a-155n, 325, and 425, gateway device 165, uCPE 165′, computing system 175, and monitoring system 180, etc.), described above with respect to FIGS. 1-5—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

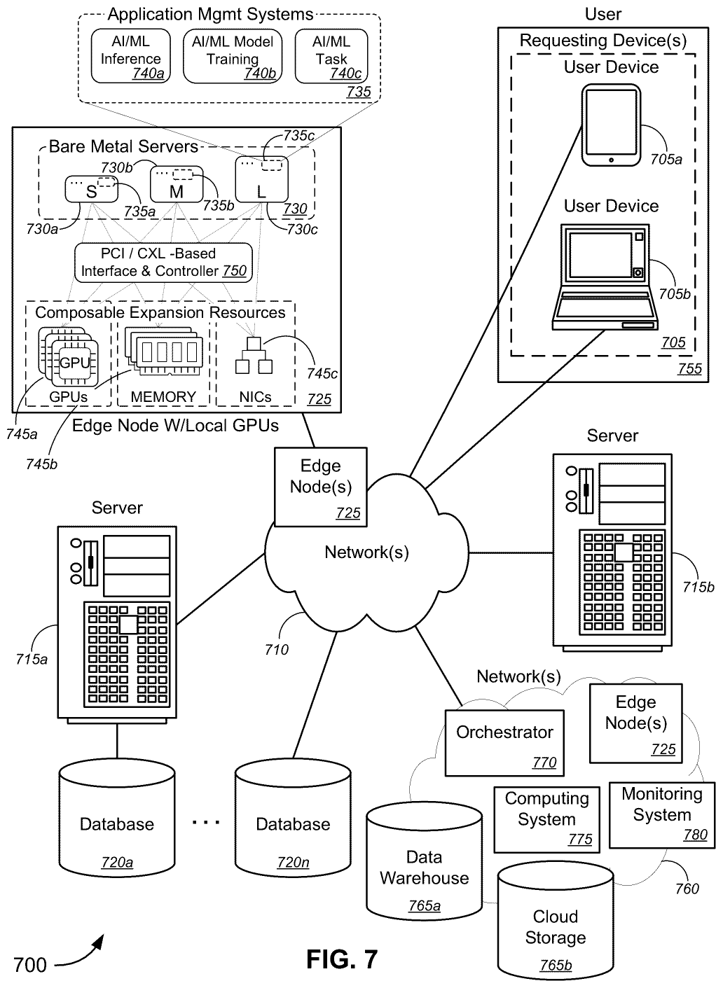

As noted above, a set of embodiments includes methods and systems for implementing network services orchestration, and, more particularly, to methods, systems, and apparatuses for implementing Inference as a Service. FIG. 7 illustrates a schematic diagram of a system 700 that can be used in accordance with one set of embodiments. The system 700 can include one or more user computers, user devices, or customer devices 705. A user computer, user device, or customer device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 705 can also have any of a variety of applications, including one or more applications configured to perform methods provided by various embodiments (as described above, for example), as well as one or more office applications, database client and/or server applications, and/or web browser applications. Alternatively, a user computer, user device, or customer device 705 can be any other electronic device, such as a thin-client computer, Internet-enabled mobile telephone, and/or personal digital assistant, capable of communicating via a network (e.g., the network(s) 710 described below) and/or of displaying and navigating web pages or other types of electronic documents. Although the exemplary system 700 is shown with two user computers, user devices, or customer devices 705, any number of user computers, user devices, or customer devices can be supported.

Certain embodiments operate in a networked environment, which can include a network(s) 710. The network(s) 710 can be any type of network familiar to those skilled in the art that can support data communications using any of a variety of commercially available (and/or free or proprietary) protocols, including, without limitation, TCP/IP, SNA™, IPX™, AppleTalk™, and the like. Merely by way of example, the network(s) 710 (similar to network(s) 145a-145c of FIGS. 1, 3, and 4, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including, without limitation, any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, a web server, a cloud computing device(s), or the like, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 705 and/or another server 715. In some embodiments, an application server can perform one or more of the processes for implementing network services orchestration, and, more particularly, to methods, systems, and apparatuses for implementing Inference as a Service, as described in detail above. Data provided by an application server may be formatted as one or more web pages (including HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer, user device, or customer device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720a-720n (collectively, “databases 720”). The location of each of the databases 720 is discretionary: merely by way of example, a database 720a might reside on a storage medium local to (and/or resident in) a server 715a (and/or a user computer, user device, or customer device 705). Alternatively, a database 720n can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

According to some embodiments, system 700 may further include one or more edge nodes 725 (similar to edge nodes or edge compute nodes 105, 105′, and 105a-105n of FIGS. 1, 3, and 4, or the like), bare metal servers 730 and 730a-730c (similar to bare metal servers 110, 110′, 110a-110c, and 110a′-110c′ of FIGS. 1, 3, and 4, or the like), application management systems 735 and 735a-735c (similar to application management systems 115, 115a-115c, and 115a′-115c′ of FIGS. 1, 3, and 4, or the like), composable expansion resources 745a-745c (similar to composable expansion resources 125 and 125a-125c of FIGS. 1, 3, and 4, or the like), PCI and/or CXL-based interface and controller 750 (similar to PCI and/or CXL-based interface and controller 130 of FIG. 1, or the like), requesting devices or user devices 705 (similar to user devices and client devices 155, 155a-155n, 325, and 425, or the like) associated with user 755, network(s) 760 (similar network(s) 145a-145c of FIGS. 1, 3, and 4, or the like), data warehouse 765a (similar to storage 140 and data warehouse 140a of FIGS. 1, 3, and 4, or the like), cloud storage 765b (similar to storage 140 and cloud storage 140b of FIGS. 1, 3, and 4, or the like), orchestrator 770 (similar to orchestrator 150 of FIGS. 1, 3, and 4, or the like), computing system 775 (similar to computing system 175 of FIGS. 1, 3, and 4, or the like), monitoring system 780 (similar monitoring system 180 of FIGS. 1, 3, and 4, or the like), or the like. The application management systems 735 and 735a-735c may include, without limitation, at least one of artificial intelligence (“AI”) and/or machine learning (“ML”) inference 740a, AI/ML model training 740b, and AI/ML task 740c, and/or the like. In some cases, customer/user 755 may include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

In operation, at least one edge compute node 725, the orchestrator 770, and/or the computing system 775 (collectively, “computing system”) may perform methods for implementing Inference as a Service, as described in detail with respect to FIGS. 1-5. For example, an example ecosystem map depicting components for implementing end-to-end AI/ML training and inferencing is described above with respect to FIG. 2, while data flows as described above with respect to FIGS. 3 and 4, which may utilize at least some of these components of FIG. 2, may be applied with respect to the operations of system 700 of FIG. 7. These and other functions of the system 700 (and its components) are described in greater detail above with respect to FIGS. 1-5. Although the examples described herein are directed to computer vision tasks or natural language (“NL”) tasks, the various embodiments may also be applicable to any suitable AI/ML tasks, further including, but not limited to, data processing tasks, ML model training tasks, image rendering tasks, video rendering tasks, and/or content generation tasks, and/or the like. These and other functions of the system 700 (and its components) are described in greater detail above with respect to FIGS. 1-5.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, a request to perform an artificial intelligence (“AI”) and/or machine learning (“ML”) task on first data, the request comprising desired characteristics and performance parameters for performing the AI/ML task;
identifying, by the computing system, one or more edge compute nodes within a network based on the desired characteristics and performance parameters;
identifying, by the computing system, one or more AI/ML pipelines that are capable of performing the AI/ML task, the identified one or more AI/ML pipelines including neural networks utilizing pre-trained AI/ML models;
causing, by the computing system, the identified one or more edge compute nodes to run the identified one or more AI/ML pipelines to perform the AI/ML task on the first data based on a corresponding pre-trained AI/ML model of each AI/ML pipeline; and
in response to receiving inference results from the identified one or more AI/ML pipelines, performing, by the computing system, at least one of sending the received inference results, storing the received inference results and sending information on a location where the received inference results are stored, or causing display of the 16 received inference results.

2. The method of claim 1, wherein the computing system comprises one of an Inference as a Service orchestrator, an AI/ML task manager, an edge compute orchestration system, an application management system, a service orchestration system, a user device associated with an entity, a server computer over the network, a cloud-based computing system over the network, or a distributed computing system.

3. The method of claim 1, wherein the request further comprises one of a location of the first data, a navigation link to the first data, or a copy of the first data.

4. The method of claim 1, wherein the request comprises the desired characteristics and performance parameters for performing the AI/ML task, without information regarding any of specific hardware, specific hardware type, specific location, or specific network for providing network services for performing the requested AI/ML task.

5. The method of claim 1, wherein the desired characteristics and performance parameters for performing the AI/ML task comprise at least one of desired latency, desired geographical boundaries, or desired level of data sensitivity for performing the AI/ML task.

6. The method of claim 1, wherein receiving the request to perform the AI/ML task on the first data comprises receiving, by the computing system and from a requesting device over the network, the request to perform the AI/ML task on the first data, wherein sending the received inference results and causing display of the received inference results each comprises causing, by the computing system, the received inference results to be sent to the requesting device for display on a display screen of the requesting device, wherein sending the location where the received inference results are stored comprises sending, by the computing system, information on a network storage location where the requesting device can access or download the received inference results for display on the display screen of the requesting device.

7. The method of claim 6, wherein the desired characteristics and performance parameters comprise at least one of a maximum latency, a range of latency values, latency restrictions, or geographical restrictions for performing the AI/ML task, wherein identifying the one or more edge compute nodes comprises identifying the one or more edge compute nodes based on at least one of proximity to the requesting device, network connections between each edge compute node and the requesting device, the at least one of the maximum latency, the range of latency values, the latency restrictions, or the geographical restrictions for performing the AI/ML task.

8. The method of claim 6, wherein receiving the request to perform the AI/ML task on the first data comprises receiving, by the computing system and from the requesting device via an application programming interface (“API”) over the network, the request to perform the AI/ML task on the first data.

9. The method of claim 8, wherein first data is uploaded to at least one of the computing system or the one or more edge compute nodes via the API, wherein causing the display of the received inference results comprises pushing the received inference results to the requesting device via the API for display on the display device of the requesting device.

10. The method of claim 1, wherein the computing system comprises a user device associated with an entity, wherein receiving the request to perform the AI/ML task on the first data comprises receiving, by a user interface device of the user device, user input comprising the request to perform the AI/ML task on the first data, wherein the identified one or more edge compute nodes comprise one or more graphics processing units (“GPUs”), wherein causing the identified one or more edge compute nodes to run the identified one or more AI/ML pipelines to perform the AI/ML task on the first data comprises causing, by the user device and over the network, the one or more GPUs to run the identified one or more AI/ML pipelines to perform the AI/ML task on the first data.

11. The method of claim 1, wherein the request is received from a client device over the network, wherein the client device has installed thereon a virtual GPU (“vGPU”) driver that is configured to manage and control one or more shared GPU resources, the one or more shared GPU resources comprising one or more composable GPUs, each composable GPU being a GPU that is one of local to each edge compute node among the identified one or more edge compute nodes or remote from said each edge compute node, wherein causing the identified one or more edge compute nodes to run the identified one or more AI/ML pipelines to perform the AI/ML task on the first data comprises causing, by the computing system and in coordination with the identified one or more edge compute nodes, the vGPU driver on client device to manage and control at least one composable GPU among the one or more composable GPUs to run the identified one or more AI/ML pipelines to perform the AI/ML task on the first data based on a corresponding pre-trained AI/ML model of each AI/ML pipeline, wherein performing the at least one of sending the received inference results, storing the received inference results and sending information on a location where the received inference results are stored, or causing display of the received inference results comprises performing, by the computing system, at least one of sending the received inference results or causing display of the received inference results.

12. The method of claim 11, wherein, for composable GPUs that are remote from the identified one or more edge compute nodes, causing the vGPU driver on client device to manage and control the at least one composable GPU among the one or more composable GPUs comprises causing execution of an instance of a virtual network function (“VNF”) on a hypervisor that is communicatively coupled to client device, wherein executing the instance of the VNF causes GPU over Internet Protocol (“IP”) functionality in which the at least one composable GPU that is remote from said each identified edge compute node is caused to perform the AI/ML task on the first data based on corresponding pre-trained AI/ML models and to provide inference results via said each identified edge compute node.

13. The method of claim 1, wherein identifying the one or more edge compute nodes further comprises identifying, by the computing system, the one or more edge compute nodes further based on unused processing capacity of each edge compute node.

14. The method of claim 1, wherein the AI/ML task comprises a computer vision task, wherein the first data comprises one of an image, a set of images, or one or more video frames, wherein performing the computer vision task comprises performing at least one of image classification, object detection, or image segmentation on at least a portion of the first data based on a corresponding pre-trained AI/ML model of each AI/ML pipeline.

15. The method of claim 14, wherein identifying the one or more AI/ML pipelines comprises:
performing, by the computing system or by an edge compute node among the identified one or more edge compute nodes, preliminary image classification to identify types of objects depicted in the first data; and
identifying, by the computing system, one or more AI/ML pipelines including neural networks utilizing models that have been pre-trained to perform computer vision tasks on the identified types of objects depicted in the first data.

16. The method of claim 1, wherein the AI/ML task comprises a natural language (“NL”) processing task, wherein the first data comprises at least one of text input, a text prompt, a dialogue context, or example prompts and corresponding responses, wherein performing the NL processing task comprises performing, by each edge compute node among the one or more edge compute nodes, at least one of text and speech processing, optical character recognition, speech recognition, speech segmentation, text-to-speech transformation, word segmentation, morphological analysis, lemmatization, morphological segmentation, part-of-speech tagging, stemming, syntactic analysis, grammar induction, sentence boundary disambiguation, parsing, lexical semantic analysis, distributional semantic analysis, named entity recognition, sentiment analysis, terminology extraction, word sense disambiguation, entity linking, relational semantic analysis, relationship extraction, semantic parsing, semantic role labelling, discourse analysis, coreference resolution, implicit semantic role labelling, textual entailment recognition, topic segmentation and recognition, argument mining, automatic text summarization, grammatical error correction, machine translation, natural language understanding, natural language generation, dialogue management, question answering, tokenization, dependency parsing, constituency parsing, stop-word removal, or text classification on at least a portion of the first data.

17. The method of claim 1, further comprising:
monitoring use of the identified one or more edge compute nodes and other network devices to track amount of consumed resources for performing the requested AI/ML task.

18. A system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the system to:
receive, from a requesting device over a network, a request to perform an artificial intelligence (“AI”) and/or machine learning (“ML”) task on first data, the request comprising desired characteristics and performance parameters for performing the AI/ML task;
identify one or more edge compute nodes within the network based on at least one of unused processing capacity of each edge compute node or the desired characteristics and performance parameters, the desired characteristics and performance parameters comprising at least one of a desired latency or geographical boundaries;
identify one or more AI/ML pipelines that are capable of performing the AI/ML task, the identified one or more AI/ML pipelines including neural networks utilizing pre-trained AI/ML models;
send instructions to each edge compute node among the identified one or more edge compute nodes to run the identified one or more AI/ML pipelines to perform the AI/ML task on the first data using a corresponding pre-trained AI/ML model of the edge compute node; and
in response to receiving inference results from the identified one or more AI/ML pipelines, perform at least one of sending the received inference results to the requesting device, storing the received inference results and sending information on a location where the received inference results are stored to the requesting device, or causing display of the received inference results on a display screen of the requesting device.

19. An edge compute node in a network, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the edge compute node to:
receive, from a client device over a network, a request to perform an artificial intelligence (“AI”) and/or machine learning (“ML”) task on first data, wherein 8 the request comprises one of a location of the first data, a navigation link to the first data, or a copy of the first data;
access the first data based on the one of the location of the first data, the navigation link to the first data, or the copy of the first data contained in the request;
cause a virtual GPU (“vGPU”) driver that is installed on the client device to manage and control at least one composable GPU among the one or more composable GPUs to run one or more AI/ML pipelines to perform the AI/ML task on the first data based on a corresponding pre-trained AI/ML model of each AI/ML pipeline, the one or more shared GPU resources comprising one or more composable GPUs, each composable GPU being a GPU that is one of local to the edge compute node or remote from the edge compute node; and
in response to receiving inference results from the one or more AI/ML pipelines, perform at least one of sending the received inference results over the network for display on a display screen of the client device or causing display of the received inference results on the display screen of the client device.

20. The edge compute node of claim 19, wherein, for composable GPUs that are remote from the edge compute node, causing the vGPU driver to manage and control the at least one composable GPU among the one or more composable GPUs comprises causing execution of an instance of a virtual network function (“VNF”) on a hypervisor that is communicatively coupled to the client device, wherein executing the instance of the VNF causes GPU over Internet Protocol (“IP”) functionality in which the at least one composable GPU that is remote from the edge compute node is caused to perform the AI/ML task on the first data based on corresponding pre-trained AI/ML models and to provide inference results the edge compute node.
